(19) United States
(12) Patent Application Publication
(10) Pub. No.: US 2026/0342178 A1
(43) Pub. Date: Oct. 29, 2026

(54) HAIRPIN TEMPERATURE SENSOR

(71) Applicant: Sensata Technologies, Inc., Attleboro, MA (US)

(72) Inventors: Petko Nikolaev Hristov, Botevgrad (BG); Hristo Zlatinov Maystorov, Sofia (BG); Nikolay Shtokmanov Tanev, Sofia (BG); Panayot Hristov Parushev, Sofia (BG)

(73) Assignee: Sensata Technologies, Inc., Attleboro, MA (US)

(21) Appl. No.: 19/073,522

(22) PCT Filed: Sep. 6, 2023
(86) PCT No.: PCT/US2023/032118

§ 371 Date: Mar. 7, 2025

Related U.S. Application Data
(60) Provisional application No. 63/404,468, filed on Sep. 7, 2022.

(51) Int. Cl. H02K 11/25; G01K 1/08; G01K 1/14; G01K 7/22

(52) U.S. Cl. CPC H02K 11/25; G01K 1/08; G01K 1/14; G01K 7/22

(57) ABSTRACT

An improved temperature sensor to determining a temperature of a stator of an e-motor includes a thermal sensor disposed in a plunger and a housing. The plunger is movable relative to the housing to position the thermal sensor relative to the stator of the e-motor.

### CROSS-REFERENCE TO RELATED APPLICATION

This application claims the benefit of International Application No. PCT/US2023/032118, filed Sep. 6, 2023, titled “Hairpin Temperature Sensor,” which claims benefit of priority of U.S. Provisional Application No. 63/404,468, filed on Sep. 7, 2022, titled “E-motor Stator Winding Welded Hairpin Temperature Sensor,” the entire disclosures of which are hereby incorporated by reference.

### FIELD OF THE TECHNOLOGY

The subject disclosure relates to sensors, and more particularly to temperature sensors for use with electrical motors

### BACKGROUND OF TECHNOLOGY

Different systems, like automobiles, are increasingly using electric motors (e-motors). However, e-motors may overheat during use, leading to motor and/or system failures. Some conventional e-motor designs incorporate a negative temperature coefficient (NTC) thermistor to monitor temperature of the stator windings of the motor. The NTC thermistor may be preferred for its relatively low component cost. However, the NTC thermistor may not be serviceable and may have relatively low accuracy. Moreover, some applications use the NTC thermistor to monitor temperature of a welded hairpin associated with a stator of the e-motor. However, tolerances associated with the welded hairpin tend to be quite large, leading to difficulties ensuring accurate temperature measurements by the NTC thermistor. Thus, there is a need in the art for an improved sensing system to prevent e-motor overheating and failures.

### BRIEF DESCRIPTION OF THE DRAWINGS

So that those having ordinary skill in the art to which the disclosed systems and techniques pertain will more readily understand how to make and use the same, reference may be had to the following drawings.

FIG. 1 is a perspective view of a temperature sensor for use with an e-motor, in accordance with aspects of this disclosure.

FIG. 2 is a perspective view of the temperature sensor of FIG. 1, with the lid removed, in accordance with aspects of this disclosure.

FIG. 3 is an exploded perspective view of portions of the temperature sensor of FIG. 1, in accordance with aspects of this disclosure.

FIG. 4A is a perspective view of portion of the temperature sensor of FIG. 1, in accordance with aspects of this disclosure.

FIG. 4B is a cross-section view of the temperature sensor, taken along the section line B-B in FIG. 4A, in accordance with aspects of this disclosure.

### DETAILED DESCRIPTION

The subject technology overcomes prior art problems associated with conventional temperatures sensors used with electronic motors. For example, the systems and techniques described herein provide a temperature sensor that facilitates measuring temperatures of motor stators in e-motors. In some examples, an e-motor may have a stator with one or more welded hairpins. The temperature of the hairpin(s) may be a good indicator of proper functioning of the e-motor (e.g., higher temperatures may signify poor motor health). The sensor systems described herein may provide improved adjustability to ensure proper sensing of a temperature of the hairpin, regardless of the locational accuracy of the hairpin in the e-motor.

In examples, temperature sensors according to this disclosure may include a plunger in which a thermal sensor, such as a thermistor, is disposed. The plunger may be retained in a housing that may be fixed relative to the e-motor. The plunger may be movable relative to the housing, e.g., laterally and/or rotationally, such that the thermal sensor may be arranged in a position to sense a temperature of the hairpin, regardless of the location of the hairpin and/or the orientation of the housing.

In some aspects of this disclosure, the housing defines a volume and an opening through a bottom of the housing. For example, the plunger may comprise a head and a shaft extending from the head along an axis. The shaft may be sized to pass through the opening in the housing, but the head may be sized to be retained in the volume of the housing. For example, the head may have outer extents larger than a diameter of the opening in the housing. An outer diameter of the shaft may be undersized relative to the opening through the housing, e.g., such that the plunger may move lateral or radially relative to the housing.

In examples of this disclosure, the plunger can also include an axial opening extending therethrough. The thermal sensor may be disposed in the axial opening, for example, proximate a distal end of the axial opening, opposite the head. In examples, the sensor may be coupled to an e-motor such that a hairpin is disposed in the axial opening, and in contact with the thermal sensor. For example, the thermal sensor may be a negative temperature coefficient thermistor. In at least some instances, the thermal sensor can include or be formed as a biasing member extending at least partially into the axial opening. As the plunger is placed over the hairpin, the hairpin may contact the biasing member with the biasing member applying a biasing force against the hairpin, to provide an improved contact between the hairpin and the thermal sensor. For instance, the moveability of the biasing member may allow for contact of the thermal sensor with the hairpin, regardless of the position of the hairpin.

In examples of this disclosure, the housing can define a volume configured to retain the head of the plunger therein. Lateral extents (e.g., in a plane normal to an axis of the plunger) of the volume may be defined at least in part by an inner surface of the housing. For instance, the inner surface may be an inner sidewall of the housing. The head may have an outer extent that is smaller than the lateral extents of the volume. Accordingly, the head may be moveable in the volume, e.g., relative to the inner surface and in the plane normal to the axis of the plunger. Accordingly, the plunger may be moveable laterally (or radially) relative to the housing.

Also in examples of this disclosure, the head of the plunger may be rotatable relative to the housing. In some examples, the head of the plunger can include a notch and the housing can include a tab projecting into the volume. When the plunger is inserted into the housing, the tab of the housing may be retained in the notch of the head of the plunger. A width of the notch may be greater than a width of the tab, such that plunger may be rotatable relative to the housing, e.g., by a rotational angle defined by the notch width and/or the tab width. In other examples, the head of the plunger may include the tab and a notch may be formed in a surface defining the volume in the housing.

According to aspects of this disclosure, an electrical connector may be coupled to the housing. For example, the electrical connector may be configured for coupling of an external system to the temperature sensor. Electrical leads may be provided to electrically connect the thermal sensor and the electrical connector. In examples, the electrical leads may be disposed in one or more of the volume defined by the housing and/or the axial opening defined by the plunger. In examples, the electrical leads may be flexible, e.g., electrical wires, to retain electrical communication of the thermal sensor and the electrical connector despite movement of the plunger relative to the housing.

According to aspects of this disclosure, the plunger may also include one or more standoffs extending from the head. In examples, the one or more standoffs may extend a distance above the head for contact by a top or cap of the housing. When the cap or top is secured to the housing, axial movement of the plunger relative to the housing is controlled or substantially eliminated. However, the relative lateral and/or rotational movements described herein may be facilitated.

In examples, the systems and techniques described herein may overcome the shortcomings of traditional thermal sensors by allowing for adjustability of a location of the thermal sensor. The systems and techniques disclosed herein may also facilitate ready replacement and installation of a temperature sensor on an e-motor. The systems and techniques disclosed herein may also improve an operational range of a vehicle using the e-motor (e.g., by ensuring the motor is functioning properly), improve safety outcomes associated with the e-motor and/or a vehicle or other systems incorporating the e-motor (e.g., by reliably sensing motor anomalies), and/or reduce assembly time.

Although aspects of this disclosure are detailed with reference to a temperature sensor for use with an e-motor additional types of sensor and/or application may benefit from the systems and techniques described herein. For example, the systems and techniques described herein may be used in other types of sensor applications, including those in which the to-be-sensed part has poor dimensional accuracy. Details of example aspects of this disclosure will now be described with reference to the figures.

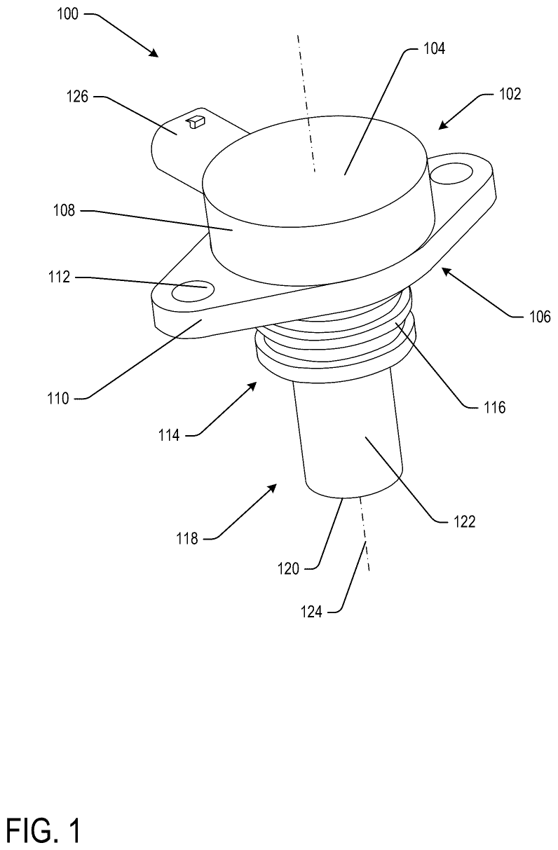

FIG. 1 is a perspective view of a temperature sensor 100 for use with an e-motor (not shown). As illustrated, the temperature sensor 100 includes a housing 102. The housing 102 is generally cylindrical, having a top surface 104, a bottom surface 106 (obscured in FIG. 1), and a generally cylindrical sidewall 108, extending between the top surface 104 and the bottom surface 106. As detailed further below, some or all of the top surface 104 may be formed as a top or cap that is selectively removable from the remainder of the housing 102, e.g., to facilitate access to a volume inside the housing 102. In other examples, the top surface 104 and some or all of the sidewall 108 may form the removable cap.

The sensor 100 is configured for coupling to an e-motor (not shown). In the example of FIG. 1, the sensor 100 includes mounting tabs 110 that extend outward from the sidewall 108 of the housing 102. The mounting tabs 110 are illustrated as including through holes 112 formed therethrough. For instance, the through holes 112 can accommodate a shaft of a fastener, e.g., a bolt, or the like, (not shown) to secure the temperature sensor 100 to a motor housing or other mounting structure. The arrangement of the through holes 112 may correspond to an arrangement of mounting holes on an e-motor. As will be apricated, the through holes 112 are for example only; additional or different mounting features may be used.

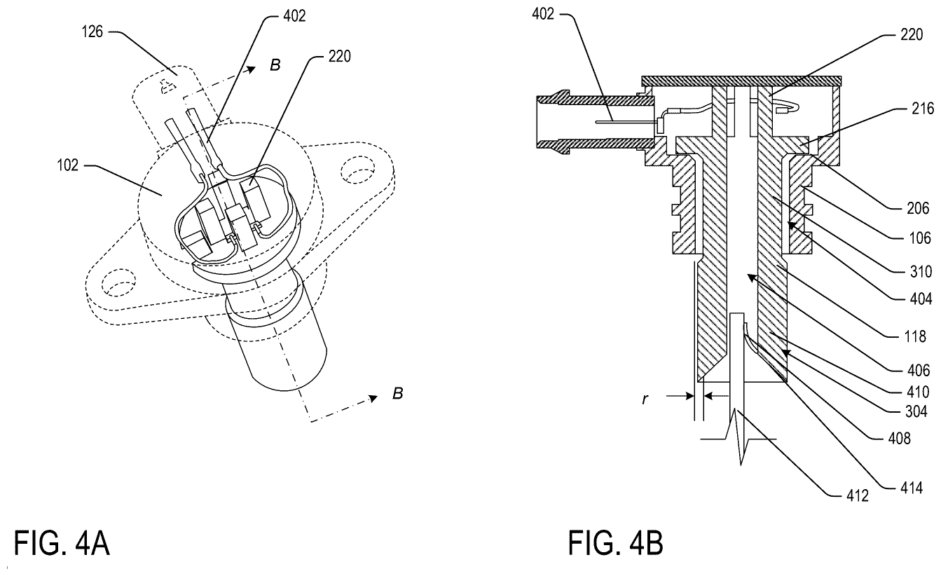

The housing 102 also includes a necked portion 114 extending from the bottom surface 106. As best shown in FIG. 4B, the necked portion 114 of the housing 102 defines an opening, e.g., an axial opening, into an inner volume of the housing 102. In examples, one or more mounting features may be formed on an outer surface of the necked portion 114. For example, the example of FIG. 1 shows a plurality of offset annular flanges 116. The annular flanges116 may be configured to cooperate with corresponding features on the motor or other mount to which the temperature sensor 100 is to be coupled. For examples, the annular flanges 116 may be sized to be disposed in, e.g., press fit into, an opening in a motor housing. In other examples, the flanges 116 may be replaced with threads and/or other structures. The shape and arrangement of the housing 102 are for example only. In other examples, the housing 102 can be other than cylindrical, there may be other than two mounting tabs 110, the mounting tabs 110 may be omitted, the necked portion 114 may be longer or shorter (or omitted), and/or the like.

The temperature sensor 100 also includes a plunger 118. As best shown in FIG. 4B (and as further detailed below), the plunger 118 is at least partially disposed in the housing 102 and extends through the necked portion 114 to a terminal end 120 spaced from the bottom surface 106 of the housing 102. In the example, the plunger 118 includes a head disposed in the housing 102 (and not visible in FIG. 1) and a shaft 122 that extends below the housing 102, generally along an axis 124. As detailed further herein, the plunger 118 may be movable relative to the housing 102, e.g., to provide for reliable temperature sensing despite relatively large tolerances associated with stator windings, as detailed further herein.

As also illustrated in FIG. 1, the temperature sensor 100 also includes a connector 126. The connector 126 may facilitate connection, e.g., electrical connection, of the temperature sensor 100 to one or more external systems (not shown). For example, and without limitation, the connector 126 may have one or more pins and/or one or more receptacles (e.g., for receiving pins) to facilitate connection to the external system. In operation, the plunger 118 is positioned proximate a stator of an e-motor (not shown) to sense a temperature associated with the stator, e.g. one or more windings of the stator, such as a hairpin winding. As detailed further herein, one or more sensing elements, such as thermistors, are disposed in the plunger 118 to generate signal(s) associated with a sensed temperature. The sensing element(s) are electrically connected to the connector 126, to facilitate transmission of the generated signal(s) to an external system, via the connector 126

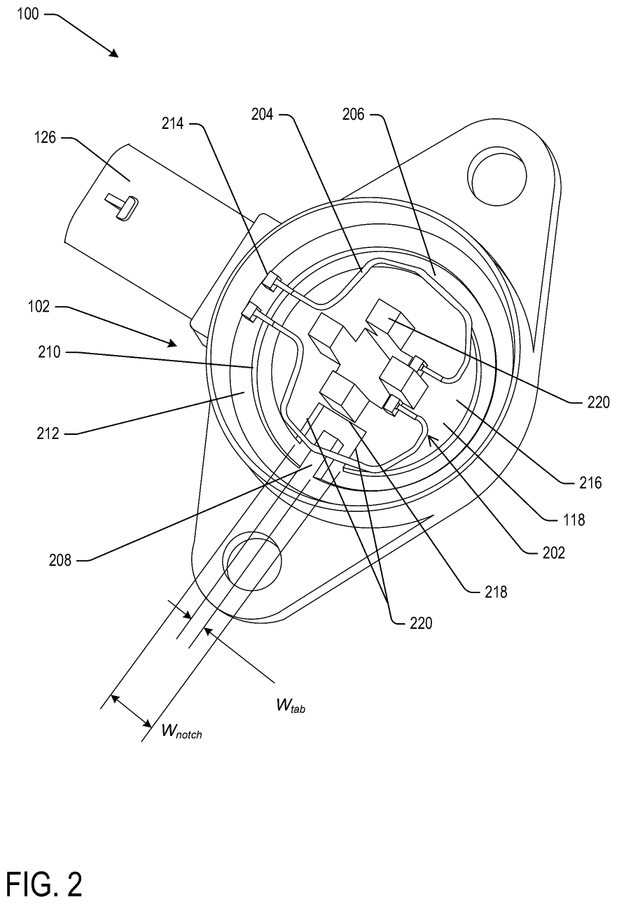

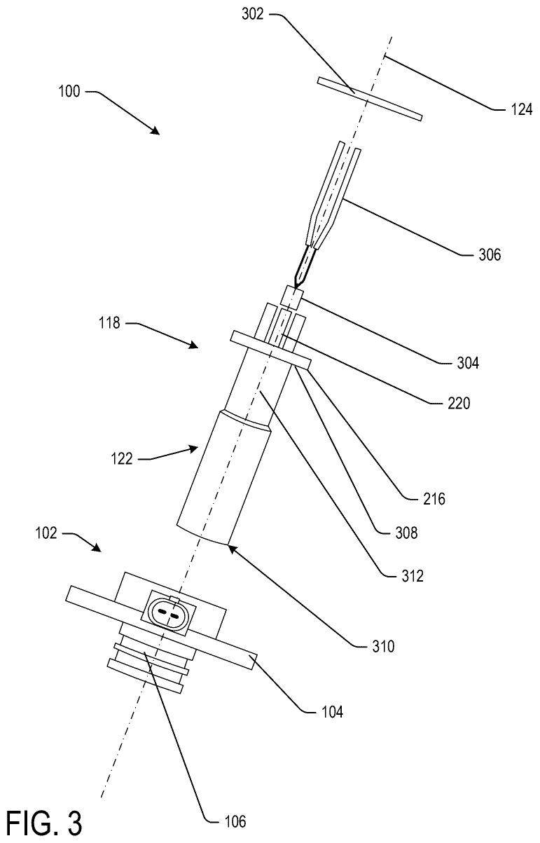

FIG. 2 is a top, perspective view of the temperature sensor 100 with a portion of the housing 102 removed to expose a volume 202 within the housing 102. In examples, and as shown in the example of FIG. 3 discussed below, the housing 102 can include a lid or top, e.g., which may include the top surface 104, that is removed in the example of FIG. 2.

As illustrated in FIG. 2, leads 204 are disposed in the volume 202 of the housing 102. The leads 204 are electrically coupled to the connector 126, e.g., to facilitate transmission of signals associated with a sensed temperature, as just discussed. In examples, the leads 204 may be flexible, e.g., configured as electrical wires, such that electrical connection is maintained during relative movement of the components of the sensor 100, as detailed herein.

As also illustrated in FIG. 2, the housing 102 includes a bottom surface or floor 206 at least partially defining a lower extent or surface of the volume 202. For example, the floor 206 may be a surface opposite the lower surface 106 of the housing 102, discussed above. A tab 208 also is provided on the floor 206. The tab 208 is formed as a protrusion extending upward from the floor 206 into the volume 202. The tab 208 also is at least partially spaced from (e.g., extends radially inwardly from) an inner surface 210. The inner surface 210 may define an outer extent of the volume 202. In the illustrated example, the inner surface 210 is formed by a stepped, annular ring 212. The annular ring 212 defines the inner surface 210 as a cylindrical opening proximate the floor 206. In other examples, the inner surface 210 may be an inner surface of the sidewall 108 of the housing 102, discussed above. For example, the annular ring 212 may be omitted.

The tab has a width, W_{tab}, e.g., generally in the circumferential dimension of the housing 102. As also shown, the tab 208 extends radially inwardly from the inner surface 210. In FIG. 2, two electrical contacts 214 are disposed on a top surface of the annular ring 212, with the leads 204 being connected to the electrical contacts 214. In other examples, the electrical contacts 214 may be positioned otherwise in the housing 102. The electrical contacts 214 are electrically connected to the connector 126.

FIG. 2 also shows a top portion of the plunger 118. The plunger 118 includes a disc or head 216 having an outer diameter sized to be received in the circumference of defined by the inner surface 210. As noted above, the shaft 122 may extend from a bottom of the head 216.

In the example illustrated in FIG. 2, a notch 218 is formed in the head 216. Specifically, the notch 218 The notch 218 has circumferentially spaced sides 220, which may be substantially parallel and define a notch width, W_{notch}. The notch 218 also has a depth, e.g., from an outer circumference of the head 216 toward a center of the head 216.

The plunger 118 also includes a plurality of posts or standoffs 222 (four of which are shown in FIG. 2) extending upward from the head 216. The standoffs 222 may be provided to contact an underside of the top of the housing 102 that has been removed in FIG. 2. For example, the standoffs 222 may prevent the plunger from moving upward relative to the housing 102, as described further herein.

For assembly, the plunger 118 is inserted (axially along the axis 124 shown in FIG. 1) into the opening defined by the necked portion 116, shown best in FIG. 4B. Once inserted, a bottom surface of the head 216 contacts the floor 206 of the housing 102. The head 216 has a larger diameter than a diameter of the opening through the necked portion 116, such that the plunger 118 does not pass completely through the opening. The plunger 118 is also disposed, rotationally, such that the tab 208 is disposed in the notch 218. Specifically, the notch width W_{notch}, is greater than the tab width W_{tab}., such that the tab 208 fits within the notch 218 when the bottom of the head 216 contacts the floor 206.

In examples of this disclosure, the notch width W_{notch} is sufficiently larger than the tab width W_{tab}, so as to provide clearance between the tab 208 and the notch 218. Because of this clearance, the plunger 118 may rotate relative to the housing 102, with the rotation being constrained only by contact of the tab 208 with the sides 220 of the notch 218. For example, the tab 208 and the notch 218 may be formed such that the head 216 can rotate relative to the housing by some rotation angle. In examples, the angle may be from about 0.5-degrees to about 10-degrees or more. As described further herein, the rotational freedom of the plunger 118 provided by the tab 208 and notch 218 arrangement can facilitate varied positioning of a sensing device coupled to the plunger 118. Moreover, the head 216 may move laterally (or radially) relative to the tab 208, e.g., because of a radial clearance between the head 216 and the inner surface 210, which may be the inner surface of the annular ring 212 and/or because of a radial (relative to a central axis of the head 216) clearance between a distal end of the tab 208 (e.g., a surface spaced farthest from the inner surface 210) and the notch 218. Accordingly, the plunger 118 may have a relatively large range of movement relative to the housing 102.

Although the head 216 of the plunger 118 is illustrated as being substantially cylindrical, e.g., as a disc, in other examples the head 216 may be otherwise shaped. Moreover, the volume 202 may be other than substantially cylindrical. As will be appreciated from this disclosure, other shapes and configurations may be used to facilitate relative movement of the plunger 118 relative to the housing 102. For example, although the illustrated example shows the head 216 as including the notch 218 and the tab 208 being formed in the volume 202, in other examples, the head 216 may be formed with a protrusion, e.g., as a tab, and the notch may be formed in the inner surface 210, the floor 206, or otherwise in the housing 102 to cooperate with the tab on the head 216. With the benefit of this disclosure, those having ordinary skill in the art will understand that other arrangements may also be used to allow some range of relative motion between the head 216 and the housing 102, e.g., in the rotational direction and/or the lateral/radial direction.

Additional details of the temperature sensor 100 are shown in FIG. 3. Specifically, FIG. 3 shows an exploded view of the temperature sensor 100, including the housing 102, the plunger 118, and a cap 302. For ease of illustration, the cap 302 was removed in FIG. 2. Also shown in FIG. 3 is a thermal sensor 304, which may be an NTC thermistor, for example. In other implementations, the thermal sensor 304 may be other than an NTC thermistor. One or more leads 306 are electrically connected to the thermal sensor 304. The one or more leads 306 are electrically coupled to the leads 204, discussed above. The thermal sensor 304 is disposed in an axial opening (shown best in FIG. 4B) extending through the plunger 118. The thermal sensor 304 may be arranged, e.g., coupled to the plunger 118, proximate a bottom of the plunger 118. In some examples, the thermal sensor 304 may be secured in the plunger 118 via a clip (also shown in FIG. 4B). In examples, the thermal sensor 304 may comprise a spring or other biasing member that is at least partially resilient, deformable, and/or deflectable. For example, the spring or biasing member may facilitate reliable and accurate contact of a stator winding hairpin or other feature to be monitored by the thermal sensor 304, e.g., by facilitating pressing against the feature to be sensed. In other examples, the clip may be a spring clip or other mounting device that is at least partially resilient, deformable, and/or deflectable that holds the sensing element. In examples, the clip may facilitate reliable and accurate contact of a stator winding hairpin or other feature to be monitored by the thermal sensor 304.

As also shown in FIG. 3, the plunger 118 is generally cylindrical, including the head 216 at a first end and the shaft 122 extending from the head 216 at a first (top) end 308 to a second (bottom) end 310. As noted above, the thermal sensor 304 may be disposed proximate the second end 310 of the plunger 118. As also illustrated in FIG. 3, an outer surface of the shaft 122 may include a reduced diameter portion 312. As detailed further herein, the reduced diameter portion 312 may be sized to provide clearance between the outer surface of the reduced diameter portion 312 and an inner surface of the neck portion 116 of the housing 102. As noted above, this clearance may facilitate relative movement (e.g., lateral movement) of the plunger 118 and the housing 102. In other examples, the entire length of the shaft 122 of the plunger 118 may have a single diameter, e.g., the reduced diameter.

FIG. 4A is a perspective view of the temperature sensor 100 with the housing 102 shown in phantom. FIG. 4A illustrates the interconnection of the leads 306 and the leads 204 to pins 402 in the connector 126.

FIG. 4B is a cross-sectional view, taken along the line B-B in FIG. 4A. FIG. 4B illustrates an axial opening 404 extending through and at least partially defined by the neck portion 116 of the housing 102. The reduced-diameter portion 312 of the plunger is disposed generally in the axial opening 404 in the neck portion 116. An outer surface of the reduced-diameter portion 312 is spaced a radial spacing, r, from an inner surface of the axial opening 404. As a result of this radial spacing, r, the plunger 118 may move radially relative to the housing 102. As detailed above, the tab 208 and notch 218 facilitate some relative rotational movement between the plunger 118 and the housing 102. Accordingly, the temperature sensor 100 allows for relative translational and rotational movement of the plunger 118 relative to the sensor housing 102.

FIG. 4B also shows the plunger 118 positioned partially in the housing 102, e.g., with the head 216 of the plunger 118 contacting the floor 206 of the housing 102, and the shaft 122 extending through the axial opening 404 through the housing and the necked portion 116, below the housing 102. As also illustrated, the standoffs 222 extend above the head 216 to a position proximate (or contacting) the cap 302. In this example, the cap 302 and the floor 206 sandwich the head 216 and standoffs 222 therebetween, e.g., to restrict (or inhibit) axial movement of the plunger 118 relative to the housing 102.

As also shown in FIG. 4B, an axial opening 406 extends through the plunger 118. Although the axial opening 406 is illustrated as extending through an entire axial length of the plunger 118, in other examples, the axial opening 406 may comprise a bore or other blind opening proximate (only) the lower end 310 of the plunger 118.

The thermal sensor 304 is disposed in the axial opening 404 extending through the plunger 118. More specifically, the thermal sensor is disposed proximate the second end 310 of the plunger 118. FIG. 4B also shows that the thermal sensor 304 incorporates a bias member 408 extending partially into the axial opening 406. The bias member 408 may be coupled to the shaft 122 of the plunger 118 by a clip 410 or other fastener. In examples, the bias member 408 may be a sensing element of the thermal sensor 304. In other examples, the bias member 408 may carry or otherwise provide a mount for a sensing element associated with the thermal sensor 304. In still further examples, the bias member 408 may be coupled, e.g., thermally coupled, to a sensing element of the thermal sensor 304. The bias member 408 may be integrated into the clip 410.

The bias member 408 is position in the axial opening 406 to contact a stator winding hairpin 412 extending at least partially into the axial opening 406. In the illustrated example, the bias member 408 includes a substantially arcuate leg that extends away from an inner surface of the axial opening 406 and generally away from the end 310 of the plunger 118. As the sensor 100 is positioned over the hairpin 412, the hairpin 412 contacts and presses against the bias member 408. The bias member 408 may be repositioned or deflected by the hairpin 412. In the example, the hairpin 412 is positioned between an inner surface of the axial opening 406 and the bias member 408. The internal force of the bias member 408 causes the bias member to maintain direct contact with the hairpin 412. As will be appreciated, because the bias member 408 extends across the axial opening 406, the exact position of the hairpin 412 relative to the plunger 118 is not crucial to achieving good contact between the bias member 408 and the hairpin 412. Moreover, because the plunger 118 is movable relative to the housing 102, and the housing 102 may be fixed relative to the hairpin 412, the sensor 100 provides further self-adjusting capabilities, to ensure reliable and accurate contact between the bias member 408 and the hairpin 412. As will also be appreciated, because the bias member 408 may comprise the thermal sensor 304 or may be in thermal contact with the thermal sensor 304, direct contact of the bias member 408 ensures proper contact for sensing at the thermal sensor 304. In examples, the bias member 408 can include spring steel or any material that facilitates biasing as detailed herein. The bias member 408 may provide a low-resistance, spring-loaded radial pressurized plunger contact that reliably and accurately measures the temperature of stator windings, and with a required step response.

FIG. 4B also illustrates a tapered surface 414 forming a part of the axial opening 406 through the shaft 122 of the plunger 118. The tapered surface 414 is proximate the second end 310 of the axial opening 406. In examples, the tapered surface 414 may be provided to guide the plunger 118 over the hairpin, e.g., as the sensor 100 is mounted to a motor. For example, during mounting of the sensor 100 on a motor, the hairpin 412 may contact the tapered surface 414 with the tapered surface 414 guiding the hairpin into the axial opening 406, e.g., as the plunger is pressed (axially) further over the hairpin 412. As the hairpin 412 contacts the tapered surface 414, continued axial pressing of the plunger causes a force at the tapered surface 414. The force will cause the plunger 118 to move relative to the housing 102, allowing the hairpin 412 to extend further into the axial opening 406 and eventually contact the bias member 408. With the hairpin disposed in the axial opening 404, the plunger 118 can also be moved (rotationally and translationally as detailed above) to effectuate contact of the thermal sensor 304 with a hairpin

As will be appreciated from the foregoing, aspects of the current disclosure provide a temperature sensing mechanism that allows for accurate temperature sensing in e-motors, even with relatively large tolerances associated with to-be-measured features, such as hairpins. In examples, this disclosure enables consistent and reliable temperature readings between the sensing element and the stator winding hairpin, which simplifies the motor control scheme, as well as enables significant reduction of system level cost (serviceability, ease of assembly, and reliability of e-motors).

All orientations and arrangements of the components shown herein are used by way of example only. Further, it will be appreciated by those of ordinary skill in the pertinent art that the functions of several elements may, in alternative embodiments, be carried out by fewer elements or a single element. Similarly, in some embodiments, any functional element may perform fewer, or different, operations than those described with respect to the illustrated embodiment. Also, functional elements shown as distinct for purposes of illustration may be incorporated within other functional elements in a particular implementation.

While the subject technology has been described with respect to preferred embodiments, those skilled in the art will readily appreciate that various changes and/or modifications can be made to the subject technology without departing from the spirit or scope of the subject technology. For example, each claim may depend from any or all claims in a multiple dependent manner even though such has not been originally claimed.

What is claimed is:

1. A sensor comprising:
a housing configured to be coupled to an electric motor;
a plunger disposed at least partially in the housing and movable relative to the housing; and
a thermal sensor disposed in the plunger, wherein the plunger is movable relative to the housing to position the thermal sensor relative to the electric motor.

2. The sensor of claim 1, wherein the plunger is movable relative to the housing to position the thermal sensor relative to a hairpin of a stator of the electric motor.

3. The sensor of claim 2, wherein the plunger includes a shaft extending below the housing, the plunger defining an axial opening configured to receive the hairpin of the stator of the electric motor therein.

4. The sensor of claim 3, wherein the thermal sensor comprises a biased contact extending into the axial opening to be contacted by the hairpin of the stator of the electric motor received in the axial opening.

5. The sensor of claim 3, wherein the plunger comprises a tapered wall proximate a distal end of the axial opening, the tapered wall being configured to guide the hairpin of the stator of the electric motor into the axial opening to a position proximate the thermal sensor.

6. The sensor of claim 1, wherein:
the housing defines an interior volume; and
the plunger comprises a head positioned in the interior volume and a shaft extending from the head along an axis to a position below the housing, the head being sized to provide a clearance between an interior surface of the housing and the head.

7. The sensor of claim 6, wherein:
the head comprises a notch formed therein,
the housing comprises a tab extending into the interior volume, and
the plunger is disposed in the housing such that the notch contains at least a portion of the tab.

8. The sensor of claim 7, wherein the notch has a notch width larger than a tab width of the tab to allow for rotation of the plunger about the axis relative to the housing.

9. The sensor of claim 1, wherein:
the housing comprises a necked portion extending from a bottom surface of the housing, the necked portion defining an axial opening having an axial opening diameter,
a portion of the plunger disposed in the necked portion has an outer diameter smaller than the axial opening diameter, and
a difference between the outer diameter of the portion and the axial opening diameter allows for lateral movement of the plunger relative to the housing.

10. The sensor of claim 9, wherein the portion of the plunger is a reduced diameter portion of a shaft of the plunger.

11. The sensor of claim 9, wherein:
the housing comprises an interior sidewall,
a head of the plunger has an outer surface spaced from the interior sidewall of the housing, and
a space between the outer surface of the head of the plunger and the interior sidewall of the housing allows for the lateral movement of the plunger relative to the housing.

12. The sensor of claim 11, wherein:
the interior sidewall is a cylindrical sidewall defining a sidewall diameter, and
the head of the plunger has a cylindrical outer surface defining a head diameter smaller than the sidewall diameter.

13. The sensor of claim 1, wherein the plunger further comprises one or more standoffs extending from a head of the plunger, the one or more standoffs configured for contacting a cap of the housing.

14. The sensor of claim 1, wherein the housing further comprises an electrical connector, the sensor further comprising:
one or more electrical leads electrically coupling the thermal sensor to the electrical connector.

15. The sensor of claim 1, wherein the thermal sensor comprises a negative temperature coefficient thermistor.
